(19) United States
(12) Patent Application Publication
(10) Pub. No.: US 2014/0290400 A1
(43) Pub. Date: Oct. 2, 2014

(54) Four Degrees Of Freedom Motion Apparatus

(71) Applicant: CJ 4D PLEX CO., LTD., Seoul (KR)

(72) Inventor: Jong Su Choi, Seoul (KR)

(73) Assignee: CJ 4D PLEX CO., LTD., Seoul (KR)

(21) Appl. No.: 14/353,450

(22) PCT Filed: Jan. 29, 2013
(86) PCT No.: PCT/KR2013/000700

§ 371 Date: Apr. 22, 2014

(30) Foreign Application Priority Data
Feb. 1, 2012 (KR) KR 10-2012-001049

(51) Int. Cl. F16H 19/08

(52) U.S. Cl. CPC F16H 19/08
USPC 74/43; 74/25

(57) ABSTRACT

The present invention relates to a four degrees of freedom motion apparatus, and more particularly, to a four degrees of freedom motion apparatus capable of implementing three degrees of freedom (pitch, roll, heave) motions by three actuators positioned at a lower plate and a center plate, and between the lower plate and the center plate, and a spline, and additionally implementing an one degree of freedom (sway) motion by a connecting means provided between the center plate and an upper plate.

### TECHNICAL FIELD

The present invention relates to a four degrees of freedom motion apparatus, and more particularly, to a four degrees of freedom motion apparatus capable of implementing three degrees of freedom (pitch, roll, heave) motions by three actuators positioned at a lower plate and a center plate, and between the lower plate and the center plate, and a spline, and additionally implementing an one degree of freedom (sway) motion by a connecting means provided between the center plate and an upper plate.

### BACKGROUND ART

Equipment, such as an aircraft or a vessel implements 6 degrees of freedom motions. As illustrated in FIG. 1, the 6 degrees of freedom motions designates six types of virtual motions including yawing which rotates with respect to a z-axis, roll in which a y-axis horizontally rotates with respect to an x-axis, pitch in which the z-axis vertically rotates with respect to the y-axis, heave which linearly reciprocates on the z-axis, surge which linearly reciprocates on the y-axis, and sway which linearly reciprocates on the x-axis. A degree of freedom motion apparatus for implementing a degree of freedom motion by driving a hydraulic actuator was initially developed for military flight training. However, the degree of freedom motion apparatus has been gradually developed to a private training apparatus, such as a railroad and a vessel, as well as a military apparatus, according to development of scientific technique and a computer graphic technology. Further, the degree of freedom motion apparatus is also used for a driver of special constructional machinery, such as a bulldozer or a crane, through a system in which a peripheral image is change in real time so as to implement simulated driving in place of actual training, which is difficult due to various problems, such as safety and costs.

Recently, since the living standards have improved and spare time readily available, the degree of freedom motion apparatus is used for the purpose of entertainment, such as an amusement park, a game simulator, and a 3D movie theater, as well as a military purpose or a training purpose.

A degree of freedom motion apparatus used in a movie field in the related art generally implements only three degrees of freedom (roll, pitch, and heave) motion by an actuator. However, in a case where only three degrees of freedom motions are implemented, it is impossible to implement various types of motions appearing in a movie, thereby reducing interests of viewers, and in order to implement the motions of four degrees of freedom or more, it is necessary to add a plurality of apparatuses, so that there is a problem in that the apparatus becomes complex, and a production cost and a maintenance cost are increased.

Further, in the three degrees of freedom motion apparatus in the related art, an actuator and a plate are hinge-coupled, so that a bending moment or torsion load may be created at a portion in which the actuator is coupled, and thus there is a problem in that a defect may be generated in the coupling portion, thereby increasing a replacement cost of equipment, and in a severe case, the coupling portion may be damaged during an operation, thereby risking an injurious accident.

Further, the three degrees of freedom motion apparatus in the related art has a structure in which a spline is not included, so that the actuator supports all power generated while confining the remaining degrees of freedom, so that there is a problem in that structural safety of the motion apparatus is unstable against a large load, and precise adjustment of the degree of freedom motion is not smooth.

### DISCLOSURE OF INVENTION

### Technical Problem

In order to solve the aforementioned problem, an object of the present invention is to provide a four degrees of freedom motion apparatus capable of additionally implementing an one degree of freedom motion by a point-contact or a surface contact between an upper plate and a center plate, implementing a precise degree of freedom motion by a spline, and controlling the degree of freedom motion.

### Solution to Problem

In order to achieve the above object, the present invention provides a four degrees of freedom motion apparatus, including: a lower plate contacting the ground; a center plate positioned while being spaced apart from the lower plate toward an upper side of the lower plate; three actuators positioned between the lower plate and the center plate, and configured to implement three degrees of freedom motions according to driving forms thereof; a spline positioned between the three actuators, and having a lower end bolt-fastened to the lower plate, and an upper end coupled to a lower portion of the center plate by a universal joint; an upper plate positioned while being spaced apart from the center plate toward an upper side of the center plate; and a connecting means configured to implement an additional one degree of freedom motion through a point-contact or surface-contact of the center plate and the upper plate.

Further, the three actuators of the four degrees of freedom motion apparatus according to another exemplary embodiment of the four degrees of freedom motion apparatus according to the present invention may be positioned in a shape of a triangle, and each of the actuators may further include: a driving motor fixedly installed in the lower plate; a decelerator connected to one side of the driving motor to decelerate rotation of the driving motor; a crank arm connected to other side of the driving motor through a ball joint; a push rod connected to one end of the crank arm through a ball joint; a fixing bracket fastened to a lower portion of the center plate; and an universal joint through which one end of the push rod is connected to the fixing bracket.

Further, the spline of the four degrees of freedom motion apparatus according to another exemplary embodiment of the four degrees of freedom motion apparatus according to the present invention may be positioned inside the triangle in which the three actuators are positioned, and may further include an elastic member installed in an external circumferential surface of the spline in order to support a load transmitted from the center plate and the upper plate.

Further, in another exemplary embodiment of the four degrees of freedom motion apparatus according to the present invention, the elastic member may be formed of a spring.

Further, in another exemplary embodiment of the four degrees of freedom motion apparatus according to the present invention, the connecting means may be formed of one or more ball bearings or roller bearings.

### Advantageous Effects of Invention

The four degrees of freedom motion apparatus according to the present invention includes the spline, thereby achieving an effect of increasing performance and stability of equipment by precisely controlling a degree of freedom motion and supporting a load applied to each actuator.

Further, the four degrees of freedom motion apparatus according to the present invention may implement an one degree of freedom (sway) motion by the upper plate and the ball bearing or the roller bearing, thereby achieving an effect of reducing a manufacturing cost and a manufacturing time thereof, and increasing satisfaction of a viewer with various degrees of freedom motions.

Further, the four degrees of freedom motion apparatus according to the present invention has an effect of increasing life of equipment and improving stability by minimizing bending stress or distortion applied to each connection portion by using the universal joint and the ball joint for the connection of the actuator and the spline.

### BRIEF DESCRIPTION OF DRAWINGS

FIG. 1 is a conceptual diagram illustrating four degrees of freedom motions.

FIG. 2 is a front view of the four degrees of freedom motion apparatus according to an exemplary embodiment of the present invention.

FIG. 3 is a side view of the four degrees of freedom motion apparatus according to an exemplary embodiment of the present invention.

FIG. 4 is a perspective view of a state in which an upper plate and a center plate are removed in the four degrees of freedom motion apparatus illustrated in FIG. 3.

FIG. 5 is an enlarged perspective view of portion A of FIG. 4.

FIG. 6 is an enlarged perspective view of portion B of FIG. 4.

FIG. 7 is a detailed view of a connecting means.

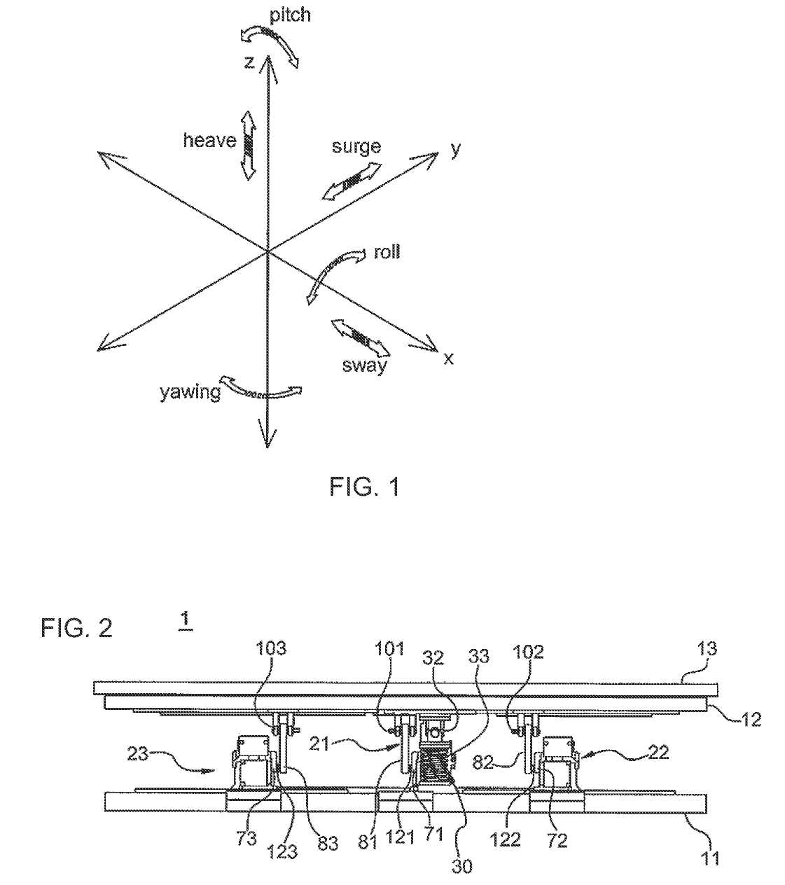

### DESCRIPTION OF MAIN REFERENCE NUMERALS OF DRAWINGS

1: Four degrees of freedom motion apparatus 11: Lower plate
12: Center plate 13: Upper plate
21, 22, 23: Acutator 30: Spline
31: Bolt-fastening 32: Universal joint
33: Elastic member 40: Connecting means
51, 52, 53: Driving motor 61, 62, 63: Decelerator
71, 72, 73: Crank arm 81, 82, 83: Push rod
91 92, 93: Fixing bracket
101, 102, 103: Universal joint
111, 112, 113: Ball joint
121, 122, 123: Ball joint

### BEST MODE FOR CARRYING OUT THE INVENTION

Hereinafter, an exemplary embodiment of the present invention will be described in detail with reference to the accompanying drawings. First of all, in giving reference numerals to elements of each drawing, like reference numerals refer to like elements.

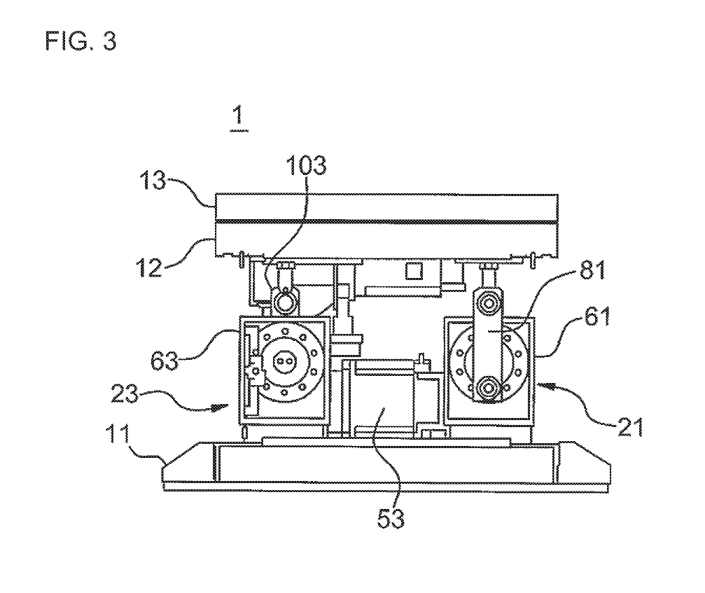

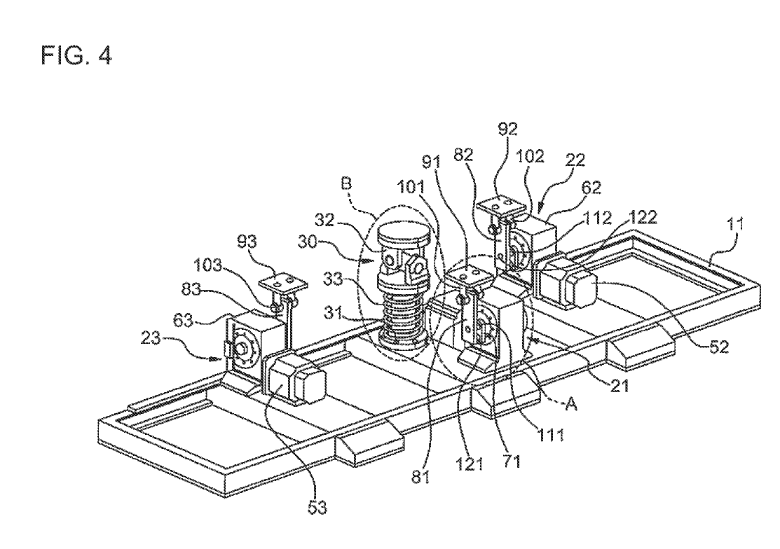

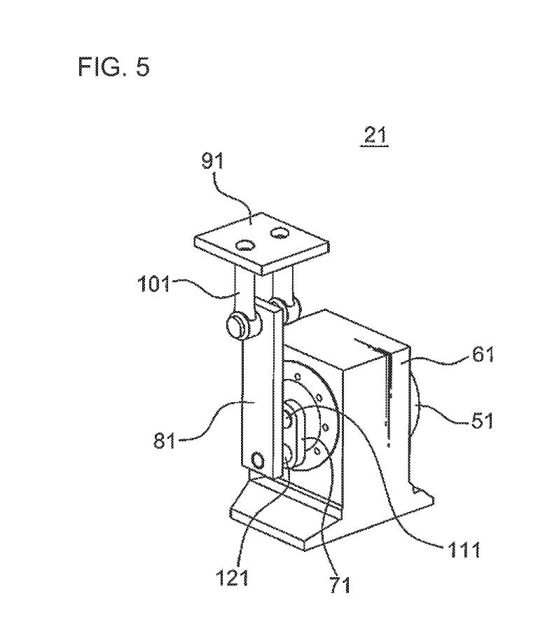

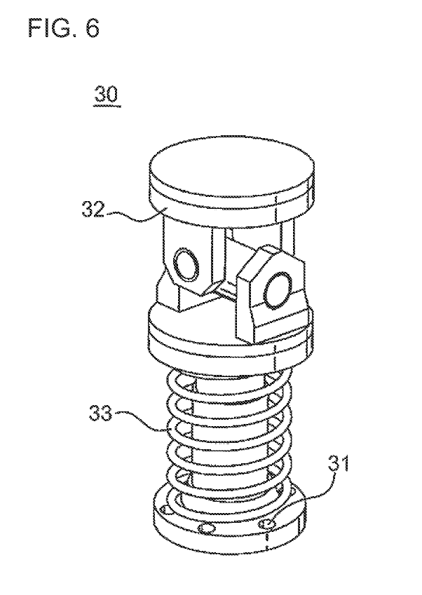

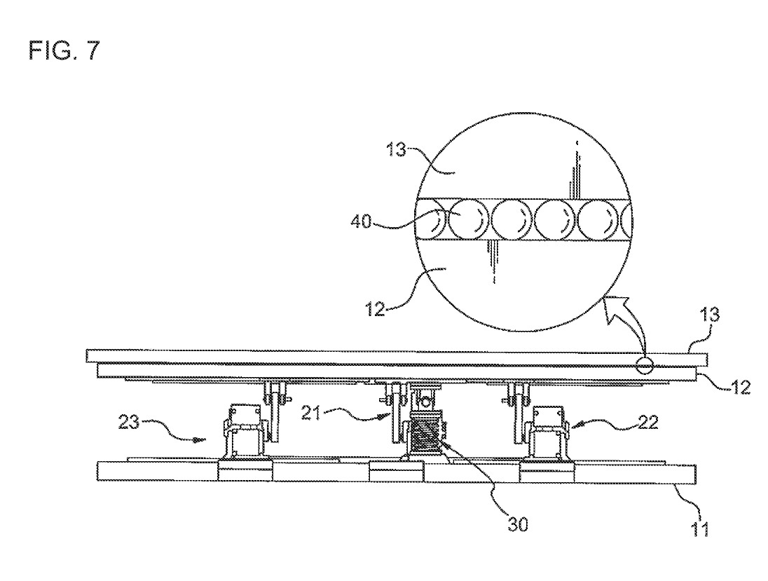

FIG. 2 is a front view of the four degrees of freedom motion apparatus 1 according to an exemplary embodiment of the present invention, and FIG. 3 is a side view of the four degrees of freedom motion apparatus 1 according to the exemplary embodiment of the present invention. FIG. 4 is a perspective view of a state in which an upper plate 13 and a center plate 12 are removed in the four degrees of freedom motion apparatus 1 illustrated in FIG. 3. FIG. 5 is an enlarged perspective view of portion A of FIG. 4, and FIG. 6 is an enlarged perspective view of portion B of FIG. 4. FIG. 7 is a detailed view of a connecting means 40. Hereinafter, the present invention will be described with reference to the drawings.

The four degrees of freedom motion apparatus 1 according to the present invention includes a lower plate 11, the center plate 12, three actuators 21, 22, and 23, a spline 30, an upper plate 13, and the connecting means 40.

As illustrated in FIGS. 2 to 4, the lower plate 11 is positioned while being in contact with the ground. The center plate 12 is positioned while being spaced apart toward an upper side of the lower plate 11. The three actuators, that is, the first, second, and third actuators 21, 22, and 23, are positioned between the lower plate 11 and the center plate 12. Three degrees of freedom motions (roll, pitch, and heave) may be implemented according to a driving form of the three actuators 21, 22, and 23. That is, in a case where a roll motion is implemented, any one between the second actuator 22 or the third actuator 23 moves up, and the actuator, which does not move up between the second actuator 22 or the third actuator 23, moves down. In a case where a pitch motion is implemented, the second and third actuators 22 and 23 both move up, and the first actuator 21 moves down, or the second and third actuators 22 and 23 both move down, and the first actuator 21 moves up. In a case where a heave motion is implemented, the first, second, and third actuators 21, 22, and 23 all move up, or the three actuators 21, 22, and 23 all move down.

As illustrated in FIG. 5, in another exemplary embodiment of the present invention, the first, second, and third actuators are positioned in a triangular shape. That is, as illustrated in FIG. 4, the first actuator 21 is positioned at a vertex of a triangle, and the second and third actuators 22 and 23 are positioned on the base line of the triangle. The first, second, and third actuators 21, 22, and 23 include first, second, and third driving motors 51, 52, and 53 fixedly installed in the lower plate 11, respectively. Although not essentially limited thereto, the first, second, and third driving motors 51, 52, and 53 are coupled to the lower plate 11 by bolt-fastening or welding. Each of first, second, and third decelerators 61, 62, and 63 is connected to one side of each of the first, second, and third driving motors 51, 52, and 53, respectively, to adjust rotation of the first, second, and third driving motors 51, 52, and 53. One ends of first, second, third crank arms 71, 72, and 73 are connected to the other sides of the first, second, and third driving motors 51, 52, and 53 through first, second, and third ball joints 111, 112, and 113, respectively. The other ends of the first, second, and third crank arms 71, 72, and 73 are connected to one ends of first, second, and third push rods 81, 82, and 83 through first, second, and third ball joints 121, 122, and 123, respectively. First, second, and third fixing brackets 91, 92, and 93 are fastened to a lower portion of the center plate 12. Although not essentially limited thereto, the first, second, and third fixing brackets 91, 92, and 93 are coupled to a lower portion of the center plate 12 by bolt-fastening or welding. The other ends of first, second, third push rods 81, 82, and 83 are connected to the first, second, and third fixing brackets 91, 92, and 93 through first, second, and third universal joints 101, 102, and 103, respectively. The crank arms 71, 72, and 73 are connected with the push roads 81, 82, and 83 through the ball joints 111, 112, 113, 121, 122, and 123, respectively, and the push roads 81, 82, and 83 are fastened to the center plate 12 through the universal joints 101, 102, and 103, so that bending stress or an axial load applied to a connection portion is minimized, thereby extending life of the actuator and improving safety.

The spline 30 is positioned between the three actuators 21, 22, and 23. A lower end of the spline 30 is bolt-fastened 31 to the lower plate 11. An upper end of the spline 30 is coupled to a lower portion of the center plate 12 through a universal joint 32.

As illustrated in FIG. 6, the spline 30 in another exemplary embodiment of the present invention is positioned inside the triangle in which the first, second, and third actuators 21, 22, and 23 are disposed. Further, the spline 30 in another exemplary embodiment of the present invention includes an elastic member 33 installed in an external circumferential surface of the spline 30 in order to support a load transmitted from the center plate 12 and the upper plate 13. The elastic member 33 may be formed of a spring. The spline 30 may precisely control the four degrees of freedom motion apparatus 1 according to the present invention according to contents of a movie, and improve stability of the apparatus by supporting a load applied to each of the actuators 21, 22, and 23.

The upper plate 13 is positioned while being spaced apart toward an upper side of the center plate 12. The center plate 12 and the upper plate 13 are connected by the connecting means 40. As illustrated in FIG. 7, the connecting means 40 in another exemplary embodiment of the present invention is formed of one or more ball bearings or roller bearings. When the center plate 12 and the upper plate 13 are connected by the ball bearing, the center plate 12 and the upper plate 13 may additionally implement one degree of freedom (sway) of linearly reciprocating in an x-axis direction while being in point-contact with each other. When the center plate 12 and the upper plate 13 are connected by the roller bearing, the center plate 12 and the upper plate 13 may implement one degree of freedom (sway) of linearly reciprocating in the x-axis direction while being in surface-contact with each other.

Although not illustrated in the drawing, a chair on which a viewer may sit is laid on an upper side of the upper plate 13. Although not limited thereto, four or more chairs are formed in one assembly to be coupled to an upper surface of the upper plate 13.

The present invention is not limited to a modification example illustrated in the drawing and the aforementioned exemplary embodiments, and may be expanded to another exemplary embodiment belonging to a scope of the accompanying claims.

### INDUSTRIAL APPLICABILITY

The present invention relates to a four degrees of freedom motion apparatus, and more particularly, to a four degrees of freedom motion apparatus capable of implementing three degrees of freedom (pitch, roll, heave) motions by three actuators positioned at a lower plate and a center plate, and between the lower plate and the center plate, and a spline, and additionally implementing an one degree of freedom (sway) motion by a connecting means provided between the center plate and an upper plate.

1. A four degrees of freedom motion apparatus, comprising:
a lower plate contacting the ground;
a center plate positioned while being spaced apart from the lower plate toward an upper side of the lower plate;
three actuators positioned between the lower plate and the center plate, and configured to implement three degrees of freedom motions according to driving forms thereof;
a spline positioned between the three actuators, and having a lower end bolt-fastened to the lower plate, and an upper end coupled to a lower portion of the center plate by a universal joint;
an upper plate positioned while being spaced apart from the center plate toward an upper side of the center plate; and
a connecting means configured to implement an additional one degree of freedom motion through a point-contact or surface-contact of the center plate and the upper plate.

2. The four degrees of freedom motion apparatus of claim 1, wherein the three actuators are positioned in a triangular shape, and each of the actuators further comprises:
a driving motor fixedly installed in the lower plate;
a decelerator connected to one side of the driving motor to decelerate rotation of the driving motor;
a crank arm connected to other side of the driving motor through a ball joint;
a push rod connected to one end of the crank arm through a ball joint;
a fixing bracket fastened to a lower portion of the center plate; and
an universal joint through which one end of the push rod is connected to the fixing bracket.

3. The four degrees of freedom motion apparatus of claim 2, wherein the spline is positioned inside the triangle, and further comprises an elastic member installed in an external circumferential surface of the spline in order to support a load transmitted from the center plate and the upper plate.

4. The four degrees of freedom motion apparatus of claim 3, wherein the elastic member is formed of a spring.

5. The four degrees of freedom motion apparatus of claim 4, wherein the connecting means is formed of one or more ball bearings or roller bearings.
